(19) United States
(12) Patent Application Publication
(10) Pub. No.: US 2025/0173720 A1
(43) Pub. Date: May 29, 2025

(54) SYSTEM AND METHOD FOR SECURING DATA TRANSFERS ACROSS MULTIPLE DEVICES ON A NETWORK

(71) Applicant: BANK OF AMERICA CORPORATION, Charlotte, NC (US)

(72) Inventors: Saurabh Arora, Gurugram (IN); Sandeep Kumar Chauhan, Hyderabad (IN); Nandini Rathaur, Mumbai (IN); Sneha Padiyar, East Mumbai (IN); Srinivas Pabolu, Hyderabad (IN)

(73) Assignee: BANK OF AMERICA CORPORATION, Charlotte, NC (US)

(21) Appl. No.: 18/521,203

(22) Filed: Nov. 28, 2023

(51) Int. Cl. G06Q 20/40; G06Q 20/38

(52) U.S. Cl. CPC G06Q 20/4014; G06Q 20/389; G06Q 20/409

(57) ABSTRACT

Systems, computer program products, and methods are described herein for securing data transfers across multiple devices on a network. The method includes receiving a transfer identifier associated with a data transfer request. The method also includes generating a transfer record associated with the transfer identifier for the data transfer request. The transfer record indicates node(s) in which the data transfer request has transmitted. The method further includes receiving a transfer data packet associated with a receiving node. The receiving node received the data transfer request from a transmitting node. The transfer data packet includes the transfer identifier. The method still further includes causing a verification signal to be transmitted to the receiving node in an instance in which the transfer data packet is verified. The method also includes updating the transfer record based on the transfer data packet.

### TECHNOLOGICAL FIELD

Example embodiments of the present disclosure relate generally to data transfer security and, more particularly, to securing data transfers across multiple devices on a network.

### BACKGROUND

Data transfers often pass through various nodes on a network. Each node has to rely on the data received from the previous node, which can result in errors and/or malfeasance. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, system for securing data transfers across multiple devices on a network is provided. The system includes at least one non-transitory storage device containing instructions and at least one processing device coupled to the at least one non-transitory storage device. The at least one processing device, upon execution of the instructions, is configured to receive a transfer identifier associated with a data transfer request. The at least one processing device, upon execution of the instructions, is also configured to create a transfer record associated with the transfer identifier for the data transfer request. The transfer record indicates one or more nodes in which the data transfer request has transmitted. The at least one processing device, upon execution of the instructions, is further configured to receive a transfer data packet associated with a receiving node. The receiving node received the data transfer request from a transmitting node. The transfer data packet includes the transfer identifier and indicates the transmitting node that sent the data transfer request to the receiving node. The at least one processing device, upon execution of the instructions, is still further configured to cause a verification signal to be transmitted to the receiving node in an instance in which the transfer data packet is verified. The transfer data packet is verified in an instance in which the transmitting node of the transfer data packet is one of the one or more nodes indicated on the transfer record. The at least one processing device, upon execution of the instructions, is also configured to update the transfer record based on the transfer data packet. The receiving node is added to the transfer record.

In various embodiments, the at least one processing device, upon execution of the instructions, is configured to cause a transmission of the transfer record to a network node with the network node using the transfer record to verify the data transfer request.

In various embodiments, the transfer record indicates a sequential ordering of one or more nodes in which the data transfer request was transmitted.

In various embodiments, the at least one processing device, upon execution of the instructions, is configured to verify the data transfer request at each node that the data transfer request is transmitted during execution. In various embodiments, the transfer data packet includes at least a portion of the data transfer request received by the receiving node.

In various embodiments, the at least one processing device, upon execution of the instructions, is configured to update the transfer data packet based on the transfer record and cause a transmission of the transfer data packet to the receiving node.

In various embodiments, the at least one processing device, upon execution of the instructions, is configured to cause a security notification to be transmitted in an instance in which the transmitting node of the transfer data packet is different than the one or more nodes indicated on the transfer record.

In various embodiments, the transfer identifier indicates one or more associated parties and a data transfer value, and the at least one processing device, upon execution of the instructions, is configured to verify the transfer data packet based on at least one of the one or more associated parties or the data transfer value.

In various embodiments, the at least one processing device, upon execution of the instructions, is configured to cause an execution of a data transfer based on the data transfer request.

In another example embodiment, a computer program product for securing data transfers across multiple devices on a network is provided. The computer program product includes at least one non-transitory computer-readable medium having computer-readable program code portions embodied therein. The computer-readable program code portions include one or more executable portions configured to receive a transfer identifier associated with a data transfer request. The computer-readable program code portions include one or more executable portions also configured to create a transfer record associated with the transfer identifier for the data transfer request. The transfer record indicates one or more nodes in which the data transfer request has transmitted. The computer-readable program code portions include one or more executable portions further configured to receive a transfer data packet associated with a receiving node. The receiving node received the data transfer request from a transmitting node. The transfer data packet includes the transfer identifier and indicates the transmitting node that sent the data transfer request to the receiving node. The computer-readable program code portions include one or more executable portions still further configured to cause a verification signal to be transmitted to the receiving node in an instance in which the transfer data packet is verified. The transfer data packet is verified in an instance in which the transmitting node of the transfer data packet is one of the one or more nodes indicated on the transfer record. The computer-readable program code portions include one or more executable portions also configured to update the transfer record based on the transfer data packet. The receiving node is added to the transfer record.

In various embodiments, the computer-readable program code portions including one or more executable portions are also configured to cause a transmission of the transfer record to a network node with the network node using the transfer record to verify the data transfer request.

In various embodiments, the transfer record indicates a sequential ordering of one or more nodes in which the data transfer request was transmitted.

In various embodiments, the computer-readable program code portions including one or more executable portions are also configured to update the transfer data packet based on the transfer record and cause a transmission of the transfer data packet to the receiving node.

In various embodiments, the computer-readable program code portions including one or more executable portions are also configured to cause a security notification to be transmitted in an instance in which the transmitting node of the transfer data packet is different than the one or more nodes indicated on the transfer record.

In still another example embodiment, a method for securing data transfers across multiple devices on a network is provided. The method includes receiving a transfer identifier associated with a data transfer request. The method also includes generating a transfer record associated with the transfer identifier for the data transfer request. The transfer record indicates one or more nodes in which the data transfer request has transmitted. The method further includes receiving a transfer data packet associated with a receiving node. The receiving node received the data transfer request from a transmitting node. The transfer data packet includes the transfer identifier and indicates the transmitting node that sent the data transfer request to the receiving node. The method still further includes causing a verification signal to be transmitted to the receiving node in an instance in which the transfer data packet is verified. The transfer data packet is verified in an instance in which the transmitting node of the transfer data packet is one of the one or more nodes indicated on the transfer record. The method also includes updating the transfer record based on the transfer data packet, wherein the receiving node is added to the transfer record.

In various embodiments, the method also includes causing a transmission of the transfer record to a network node with network node using the transfer record to verify the data transfer request.

In various embodiments, the transfer record indicates a sequential ordering of one or more nodes in which the data transfer request was transmitted.

In various embodiments, the method also includes updating the transfer data packet based on the transfer record and causing a transmission of the transfer data packet to the receiving node.

In various embodiments, the method also includes causing a security notification to be transmitted in an instance in which the transmitting node of the transfer data packet is different than the one or more nodes indicated on the transfer record.

In various embodiments, the method also includes causing an execution of a data transfer based on the data transfer request.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an example distributed computing environment for securing data transfers across multiple devices on a network, in accordance with various embodiments of the present disclosure; and

FIGS. 2A and 2B illustrate a process flow for securing data transfers across multiple devices on a network, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data. An “entity” can encompass a wide range of organizations, such as institutions, groups, associations, financial institutions, establishments, companies, unions, authorities, and similar entities. The common factor among these entities is their utilization of information technology resources for processing substantial amounts of data. As such, an “entity” in this context denotes any organization or institution that employs information technology resources capable of processing large volumes of data, which can pertain to different aspects of the entity's operations.

As described herein, a “user” may be an individual associated with an entity. As such, in some embodiments, the user may be an individual having past relationships, current relationships or potential future relationships with an entity (e.g., a customer at a financial institution).

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device. Additionally, as used herein, a “resource” may also encompass computing or network resources. This broader definition of a resource includes elements such as computational power, storage capacity, network bandwidth, software applications, databases, virtual machines, servers, routers, switches, and other similar components associated with computing or network infrastructure.

As used herein, an “artificial intelligence” (AI) system is a computing framework designed to perform tasks that normally require human intelligence, such as understanding natural language, recognizing patterns, problem-solving, and making decisions. It is understood that these systems operate by mimicking the neural networks of humans in a simplified form. In some embodiments, they may consist of interconnected layers of nodes, often referred to as artificial neurons, that process information using dynamic state responses to external inputs. They are trained by feeding them large volumes of data and adjusting the connections between the nodes using complex mathematical algorithms based on the principles of statistics and calculus, allowing them to learn from this data. In some embodiments, an AI system may be stored and executed in various ways depending on the requirements of the specific implementation. It is understood that AI systems can be hosted on local machines, in data centers, or in the cloud. It is further understood that cloud-based AI systems are becoming increasingly common due to their scalability, cost-effectiveness, and the ability to handle vast amounts of data. AI systems may be employed for identifying data patterns and vulnerability vectors due to their ability to analyze large and complex datasets rapidly and accurately.

Data transfers, such as resource transfer, are carried out by transmitting information relating to the data transfer request across multiple nodes in a network. As such, each node may perform one or more operations relating to the data transfer. However, the various transmissions allow for increased malfeasance. For example, in an instance a single node is compromised, the node may enrich the data transfer request such that the entire data transfer is compromised and/or the other nodes on the network also become compromised. Currently, each node relies on the data provided from other nodes to carry out operations without any verification process. As such, non-malfeasant nodes may nonetheless facilitate malfeasant behavior without being aware of the malfeasance. Current methods to secure individual node and validate data packets are deficient and time-consuming, resulting in delays with little to no improved security. As such, the present disclosure improves node processing security without causing delays.

Various embodiments of the present disclosure allow for securing data transfers across multiple devices on a network. To do this, each data transfer request (e.g., initiation of a resource transfer, such as a transaction) may be assigned a transfer identifier. The transfer identifier may be one or more alphanumerical characters or other identifier(s) that may be used throughout execution of the data transfer request. A transfer record is also generated that is associated with the data identifier that records each node that receives and/or transmits the data transfer request for processing. As such, each node in the network may communicate with the system at each step of processing of the data transfer request to verify the information received based on the transfer record. The system may also enrich information relating to the data transfer request for nodes by providing information included in the transfer record. As such, the transfer record is used to verify each transmission relating to the data transfer request and the transfer record is updated to include each node along the transmission path.

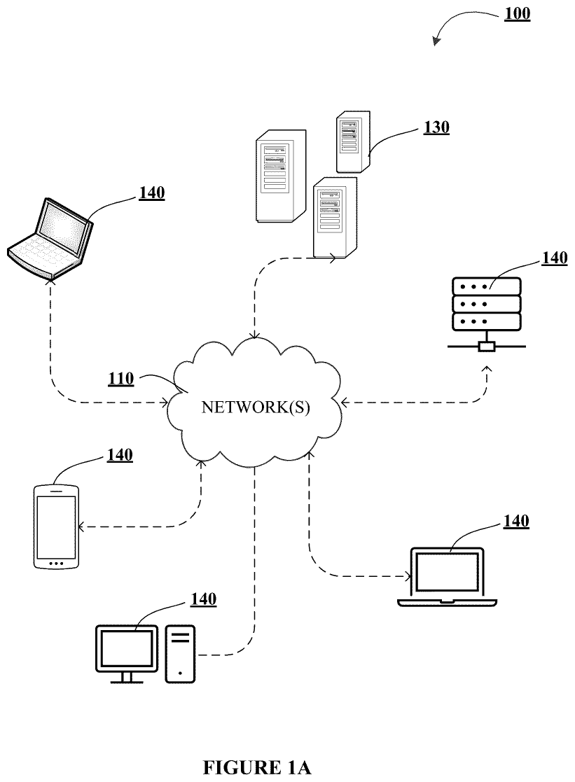

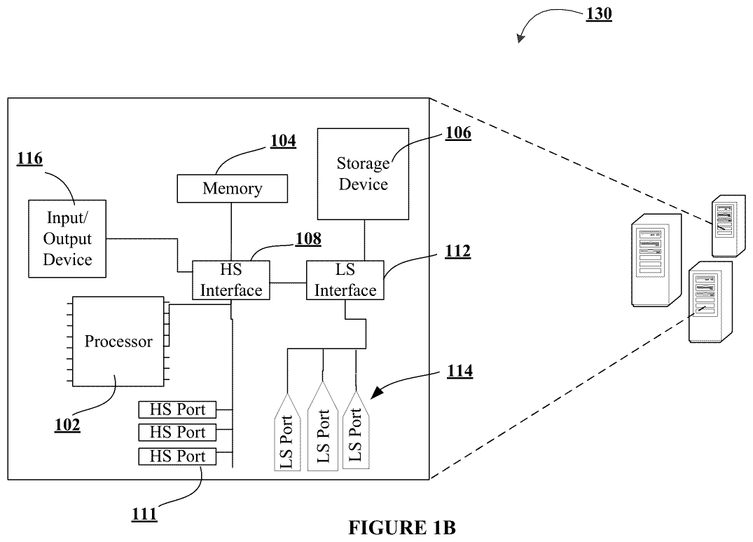

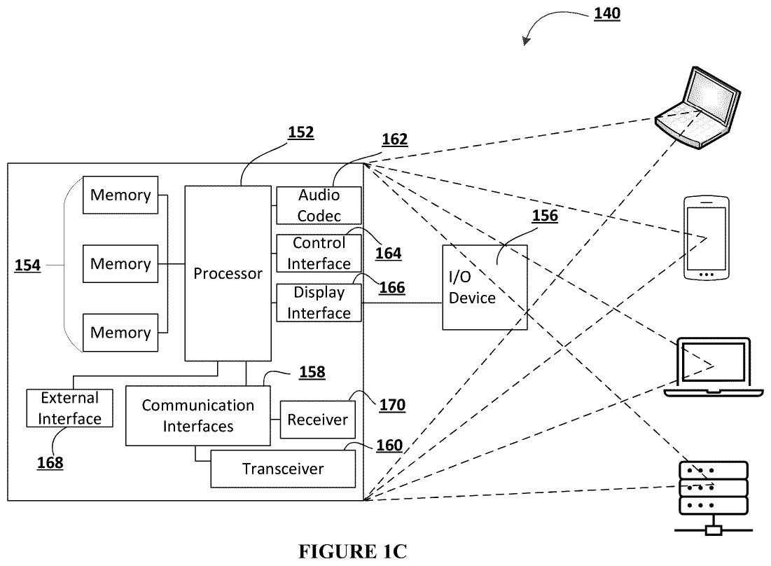

FIGS. 1A-1C illustrate technical components of an example distributed computing environment for securing data transfers across multiple devices on a network, in accordance with an embodiment of the disclosure. As shown in FIG. 1A, the distributed computing environment 100 contemplated herein may include a system 130 (e.g., a network monitoring device), an end-point device(s) 140, and a network 110 over which the system 130 and end-point device(s) 140 communicate therebetween. In various embodiments, the system 130 may be embodied by one or more of the end-point devices 140. As such, any end-point device 140 may operate as the system 130.

FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to the shared communication within the network, the distributed network often also supports distributed processing. The network 110 may be a form of digital communication network such as a telecommunication network, a local area network (“LAN”), a wide area network (“WAN”), a global area network (“GAN”), the Internet, a satellite network, a cellular network, and/or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an example component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 (shown as “HS Interface”) connecting to the memory 104, and a low-speed interface 112 connecting to low-speed expansion port 114 (shown as “LS Port”) and storage device 106. Each of the components 102, 104, 106, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-readable or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an example component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

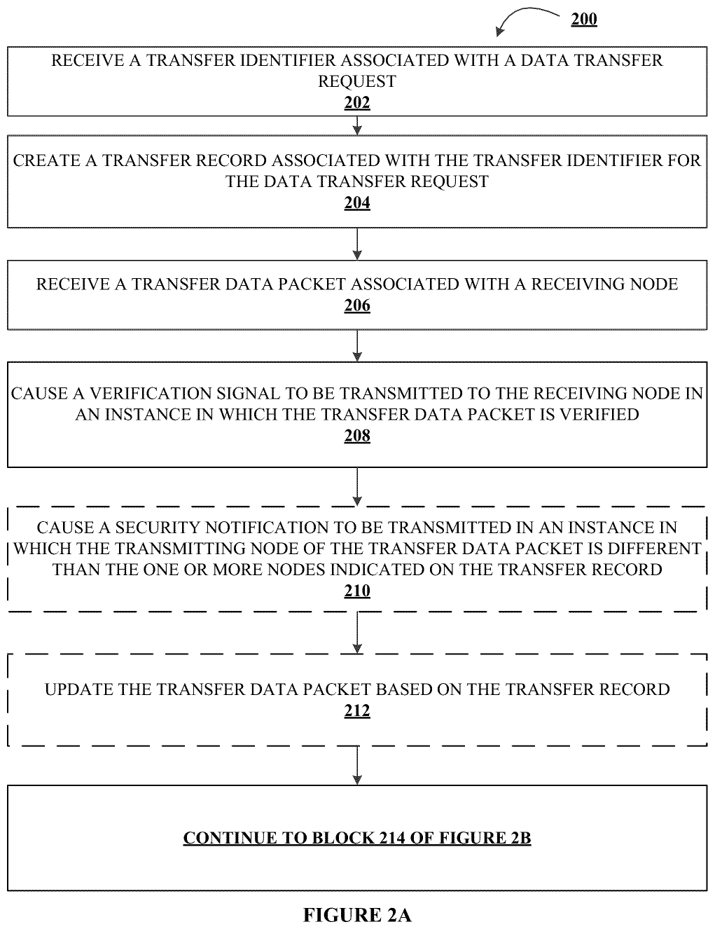

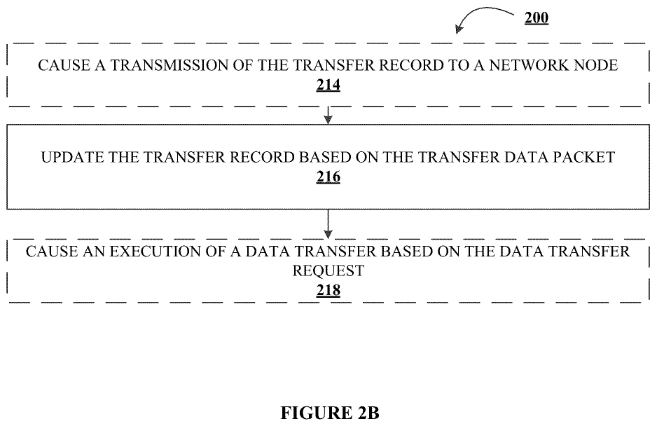

FIGS. 2A and 2B illustrates a process flow for securing data transfers across multiple devices on a network, in accordance with various embodiments of the present disclosure. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein.

In various embodiments, one or more of the end-point devices 140 associated with the network may be capable of executing one or more features of the process flow discussed herein. As such, each of the one or more of the end-point devices 140 associated with the network may include hardware to carry out the operations herein. Additionally, as discussed herein, various software programs and/or applications may be installed on a given end-point device to conduct the operations discussed herein. In various embodiments, the first end-point device, second end-point device, third end-point device, etc. may refer to any of the end-point device on the network. Additionally, a receiving node and a transmitting node may refer to various nodes (e.g., a given node may be both a receiving node and a transmitting node).

Referring now to Block 202 of FIG. 2A, the method includes receiving a transfer identifier associated with a data transfer request. A transfer identifier may be any marker or indicator that references the data transfer request. In various embodiments, the transfer identifier may be one or more alphanumerical characters that are used to identify the data transfer request. Additionally or alternatively, the transfer identifier may be any indicator of identification (e.g., picture, QR code, etc.) that allows the system to associate the transfer identifier and any information that includes the transfer identifier with the associated data transfer request. The transfer identifier may be used to identify a data transfer being executed (e.g., in response to a data transfer request).

The data transfer request may include information relating to a data transfer to be executed. For example, the data transfer request may be associated with a resource transfer. As such, the data transfer request may include associated parties (e.g., a sending account and/or user, a receiving account and/or user, etc.), a transfer value (e.g., resource value), a transfer type, the date and/or time of the data transfer request and/or the data transfer, and/or the like.

Each data packet transmitted relating to the data transfer request may be tagged with the transfer identifier. As such, any transmission across nodes may include the transfer identifier. The transfer identifier may be used at each step of a data transfer execution to verify the transfer data packet and provide additional information to the node(s) to execute the data transfer. For example, the system may provide information, such as the financial institution associated with one or more parties of the data transfer, the transfer value, the date/time of the data transfer request and/or the data transfer, the transfer value, and/or the like.

In various embodiments, the transfer identifier may be used to retrieve information relating to the data transfer request. For example, a given node may transmit the transfer identifier to a receiving node that may then retrieve information relating to the data transfer request using the transfer identifier (e.g., via the system and/or an eternal database or source).

Referring now to Block 204 of FIG. 2A, the method includes creating a transfer record associated with the transfer identifier for the data transfer request. The transfer record may include information relating to the data transfer request, such as transfer information (e.g., associated parties, transfer value, etc.). In various embodiments, the transfer record may include one or more nodes in which the data transfer request has been transmitted. A node may be recorded into the transfer record in an instance in which a node provides the transfer identifier to the system (e.g., the transfer identifier may be included in the transfer data packet discussed herein). As such, the system may consider a node as one of the one or more nodes in which the data transfer request has been transmitted in an instance in which the given node provides the transfer identifier.

In various embodiments, the transfer record may include transmission information between node relating to the data transfer request. For example, the transfer record may include the transmitting node that transmitted the transfer request to the given receiving node. As such, the transfer record may record each node along a transmission sequence may cause a transmission to the system, such that the system records each node along the transmission sequence. For example, the transfer record may indicate a sequential ordering of the one or more nodes in which the data transfer request was transmitted. As such, the transfer record may include a chain of command for the data transfer request. Additionally, as a data transfer may include multiple transmissions between the network nodes, the transfer record may indicate each instance in which each node received and/or transmitted the data transfer request.

Referring now to Block 206 of FIG. 2A, the method includes receiving a transfer data packet associated with a receiving node. The transfer data packet may be any transmission that includes the transfer identifier. In various embodiments, the transfer data packet may also include the transmitting node that transmitted the data transfer request to the given receiving node. Additionally or alternatively, the transfer data packet may also include other information relating to the data transfer request. In various embodiments, the transfer data packet may include at least a portion of the data transfer packet may include the data transfer request and/or information contained in the data transfer request.

In various embodiments, a receiving node may be any node that receives a data transfer request, and a transmitting node may be any node that transmits the data transfer request. As such, a node may be a receiving node and/or a transmitting node. For example, a first node may transmit the data transfer request to a second node, that then transmits the data transfer request to a third node, such that the first node may be a transmitting node, the second node may be both a receiving node and a transmitting node, and the third node may be a transmitting node.

As used herein, the data transfer request may be any portion of the initial data transfer request. As such, each node may modify or otherwise update the data transfer request before transmitting the data transfer request to another node. In various embodiments, the data transfer request may be considered transmitted to another node in any instance in which a network node transmits any information relating to the data transfer request to another node. For example, a transmitting node may transmit only the transfer identifier and still be considered as transmitting the transfer data request.

In various embodiments, the transfer data packet may be the data transfer request (e.g., the receiving node may transmit the same data packet(s) received from the transmitting node to the system for processing). Additionally or alternatively, the transfer data packet may be distinct from, but related to the data transfer request (e.g., the receiving node may transmit the transfer identifier to the system and the system may determine information relating to the data transfer request based on the transfer identifier).

Referring now to Block 208 of FIG. 2A, the method includes causing a verification signal to be transmitted to the receiving node in an instance in which the transfer data packet is verified. A transfer data packet may be verified based on the transfer record. For example, the transfer data packet is verified in an instance in which the transmitting node of the transfer data packet is one of the one or more nodes indicated on the transfer record.

In various embodiments, the system may verify the data transfer request may be verified at each node that the data transfer request is transmitted during execution. For example, each node may transmit a transfer data packet that includes the transfer identifier to the system to verify as used herein (e.g., the system may verify the transfer data packet based on the transfer record for the given data transfer request).

In various embodiments, a transfer data packet may be verified based on one or more indicators determined via the transfer indicator. For example, the transfer identifier may indicate one or more associated parties and a data transfer value, and any of the associated parties and/or the data transfer value may be used to verify a transfer data packet. As such, the method may include verifying the transfer data packet based on at least one of the one or more associated parties or the data transfer value. For example, a transfer data packet may have a transfer identifier along with a data transfer value received from a transmitting node of the network. In such an example, the data transfer value received in the transfer data packet may be compared to the data transfer value of the initially received data transfer request, which may be recorded in the transfer record. In an instance in which the data transfer value received in the transfer data packet and the data transfer value of the initially received data transfer request are the same, the transfer data packet may be verified, while in an instance in which data transfer value received in the transfer data packet and the data transfer value of the initially received data transfer request are different, the transfer data packet may not be verified (e.g., the transfer data packet may be marked as malfeasant, marked for additional review, etc.).

Referring now to optional Block 210 of FIG. 2A, the method includes causing a security notification to be transmitted in an instance in which the transmitting node of the transfer data packet is different than the one or more nodes indicated on the transfer record. In various embodiments, in an instance in which a transfer data packet is not verified, the transfer data packet may be marked for additional review. For example, in an instance the transmitting node of a transfer data packet does not match any nodes of the transfer record, the transfer data packet may be potentially malfeasant. As such, a security notification may be generated with information relating to the potential malfeasance.

In various embodiments, the security notification may be transmitted to the node that transmitted the transfer data packet to the system. As such, the node may take security measures based on the security notification (e.g., locking the node, not processing any data transfer requests received from the given transmitting nodes, performing diagnostics, and/or the like).

In various embodiments, the security notification may be recorded on the transfer record. As such, each subsequent node that communicates with the system about the given data transfer request may be notified (e.g., the system may indicate to one or more nodes that a data transfer request (e.g., or associated transfer identifier) has been subject to a security notification. As such, the execution of the data transfer request may be limited or completely stopped based on the security notification.

In various embodiments, the security notification may be transmitted to one or more end-point devices associated with the network. For example, a system administrator or other network user may receive the security notification in order to investigate the potential malfeasance.

Referring now to optional Block 212 of FIG. 2A, the method includes updating the transfer data packet based on the transfer record. In various embodiments, the transfer data packet may include incomplete information relating to the data transfer request. For example, the data transfer request may not include information associated with data transfer request (e.g., associated parties, transfer value, transfer type, etc.). In such an instance, the system may update the transfer data packet with such information. Updating the transfer data packet may include actual modifications to the transfer data packet, along with transmitting the updated transfer data packet. Alternatively, updating the transfer data packet may be transmitting information relating to the data transfer request to the given node that transmitted the transfer data packet.

Referring now to optional Block 214 of FIG. 2B, the method includes causing a transmission of the transfer record to a network node. A network node may be any node on a network. For example, a network node may be a receiving node and/or transmitting node as used herein. In various embodiments, the system may transmit the transfer record (or a portion of the transfer record) to one or more nodes in the network. In such an instance, the node may use the transfer record to verify a data transfer request independently and/or in combination with the system verifying the transfer data packet from the given node. As such, the verification process discussed herein may also be carried out by individual nodes.

Referring now to Block 216 of FIG. 2B, the method includes updating the transfer record based on the transfer data packet. In various embodiments, the transfer record may be updated by adding the receiving node to the transfer record. In various embodiments, the transfer record may be updated throughout the data transfer process (e.g., tracking each node that transmits and/or receives any transfer data packets relating to the data transfer).

The transfer record may also be update in various ways based on the operations of the execution of the data transfer request. For example, the transfer record may indicate the sequential ordering of transmissions across nodes, the type and/or amount of data transmitted by each node, the nodes that communicated directly with one another, network conditions, and/or the like.

Referring now to optional Block 218 of FIG. 2B, the method includes causing an execution of a data transfer based on the data transfer request. In various embodiments, the system may facilitate the execution of the data transfer requested by the data transfer request. As such, causing an execution of a data transfer based on the data transfer request may include verifying the one or more transmissions across nodes, such that the nodes may execute the data transfer more securely.

In various embodiments, the system may also cause the data transfer to be executed based on information provided via one or more nodes in the network. For example, the system may receive transfer data packet(s) from node(s) that include the transfer data request, such that the system carries out operation(s) associated with the data transfer. In such an instance, the system may also act as a node as discussed herein.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for securing data transfers across multiple devices on a network, the system comprising:
at least one non-transitory storage device containing instructions; and
at least one processing device coupled to the at least one non-transitory storage device, wherein the at least one processing device, upon execution of the instructions, is configured to:
receive a transfer identifier associated with a data transfer request;
create a transfer record associated with the transfer identifier for the data transfer request, wherein the transfer record indicates one or more nodes in which the data transfer request has transmitted;
receive a transfer data packet associated with a receiving node, wherein the receiving node received the data transfer request from a transmitting node, wherein the transfer data packet comprises the transfer identifier and indicates the transmitting node that sent the data transfer request to the receiving node;
cause a verification signal to be transmitted to the receiving node in an instance in which the transfer data packet is verified, wherein the transfer data packet is verified in an instance in which the transmitting node of the transfer data packet is one of the one or more nodes indicated on the transfer record; and
update the transfer record based on the transfer data packet, wherein the receiving node is added to the transfer record.

2. The system of claim 1, wherein the at least one processing device, upon execution of the instructions, is configured to cause a transmission of the transfer record to a network node, wherein the network node uses the transfer record to verify the data transfer request.

3. The system of claim 1, wherein the transfer record indicates a sequential ordering of one or more nodes in which the data transfer request was transmitted.

4. The system of claim 1, wherein the at least one processing device, upon execution of the instructions, is configured to verify the data transfer request at each node that the data transfer request is transmitted during execution.

5. The system of claim 1, wherein the transfer data packet comprises at least a portion of the data transfer request received by the receiving node.

6. The system of claim 1, wherein the at least one processing device, upon execution of the instructions, is configured to:
update the transfer data packet based on the transfer record; and
cause a transmission of the transfer data packet to the receiving node.

7. The system of claim 1, wherein the at least one processing device, upon execution of the instructions, is configured to cause a security notification to be transmitted in an instance in which the transmitting node of the transfer data packet is different than the one or more nodes indicated on the transfer record.

8. The system of claim 1, wherein the transfer identifier indicates one or more associated parties and a data transfer value, and wherein the at least one processing device, upon execution of the instructions, is configured to verify the transfer data packet based on at least one of the one or more associated parties or the data transfer value.

9. The system of claim 1, wherein the at least one processing device, upon execution of the instructions, is configured to cause an execution of a data transfer based on the data transfer request.

10. A computer program product for securing data transfers across multiple devices on a network, the computer program product comprising at least one non-transitory computer-readable medium having computer-readable program code portions embodied therein, the computer-readable program code portions comprising one or more executable portions configured to:
receive a transfer identifier associated with a data transfer request;
create a transfer record associated with the transfer identifier for the data transfer request, wherein the transfer record indicates one or more nodes in which the data transfer request has transmitted;
receive a transfer data packet associated with a receiving node, wherein the receiving node received the data transfer request from a transmitting node, wherein the transfer data packet comprises the transfer identifier and indicates the transmitting node that sent the data transfer request to the receiving node;
cause a verification signal to be transmitted to the receiving node in an instance in which the transfer data packet is verified, wherein the transfer data packet is verified in an instance in which the transmitting node of the transfer data packet is one of the one or more nodes indicated on the transfer record; and
update the transfer record based on the transfer data packet, wherein the receiving node is added to the transfer record.

11. The computer program product of claim 10, wherein the computer-readable program code portions comprising one or more executable portions are also configured to cause a transmission of the transfer record to a network node, wherein the network node uses the transfer record to verify the data transfer request.

12. The computer program product of claim 10, wherein the transfer record indicates a sequential ordering of one or more nodes in which the data transfer request was transmitted.

13. The computer program product of claim 10, wherein the computer-readable program code portions comprising one or more executable portions are also configured to:
update the transfer data packet based on the transfer record; and
cause a transmission of the transfer data packet to the receiving node.

14. The computer program product of claim 10, wherein the computer-readable program code portions comprising one or more executable portions are also configured to cause a security notification to be transmitted in an instance in which the transmitting node of the transfer data packet is different than the one or more nodes indicated on the transfer record.

15. A method for securing data transfers across multiple devices on a network, the method comprising:
receiving a transfer identifier associated with a data transfer request;
generating a transfer record associated with the transfer identifier for the data transfer request, wherein the transfer record indicates one or more nodes in which the data transfer request has transmitted;
receiving a transfer data packet associated with a receiving node, wherein the receiving node received the data transfer request from a transmitting node, wherein the transfer data packet comprises the transfer identifier and indicates the transmitting node that sent the data transfer request to the receiving node;
causing a verification signal to be transmitted to the receiving node in an instance in which the transfer data packet is verified, wherein the transfer data packet is verified in an instance in which the transmitting node of the transfer data packet is one of the one or more nodes indicated on the transfer record; and
updating the transfer record based on the transfer data packet, wherein the receiving node is added to the transfer record.

16. The method of claim 15, further comprising causing a transmission of the transfer record to a network node, wherein the network node uses the transfer record to verify the data transfer request.

17. The method of claim 15, wherein the transfer record indicates a sequential ordering of one or more nodes in which the data transfer request was transmitted.

18. The method of claim 15, further comprising:
updating the transfer data packet based on the transfer record; and
causing a transmission of the transfer data packet to the receiving node.

19. The method of claim 15, further comprising causing a security notification to be transmitted in an instance in which the transmitting node of the transfer data packet is different than the one or more nodes indicated on the transfer record.

20. The method of claim 15, further comprising causing an execution of a data transfer based on the data transfer request.
